(19) United States
(12) Patent Application Publication
(10) Pub. No.: US 2005/0246194 A1
(43) Pub. Date: Nov. 3, 2005

(54) System and method for information disclosure statement management

(76) Inventor: Steven W. Lundberg, Edina, MN (US)

Correspondence Address: Schwegman, Lundberg, Woessner & Kluth, P.A., P.O. Box 2938, Minneapolis, MN, 55402, US

(21) Appl. No.: 11/098,761

(22) Filed: Apr. 4, 2005

Related U.S. Application Data
(60) Provisional application No. 60/559,946, filed on Apr. 6, 2004.

(51) Int. Cl. G06F 17/60

(52) U.S. Cl. 705/1

(57) ABSTRACT

The present inventive subject matter relates to document management, more particularly to a system and method for information disclosure statement management. Various embodiments of the present inventive subject matter include systems and methods for tracking reference documents relevant to pending patent applications that includes electronically comparing keywords from a pending claim set with reference document text to automatically determine if a reference document needs to be submitted to a patent office for a pending patent application. Further embodiments include performing electronic analysis on a reference document based on various elements of the reference document in view of elements of a pending patent application. In some embodiments, the analysis includes a keyword analysis to derive a score which is useful in determining if a document should be disclosed to a patenting authority for a pending patent application.

### RELATED APPLICATIONS

This application claims the benefit of the filing date of U.S. Provisional Application Ser. No. 60/559,946 filed Apr. 6, 2004, which application is incorporated herein by reference.

This application is related to U.S. patent application Ser. No. 10/087,561, entitled “Web-Based Inventory System For Documents Cited in an Information Disclosure Statement,” filed on Mar. 1, 2002, to U.S. patent application Ser. No. 10/033,192, entitled “Docket Verification and Data Management System,” filed on Dec. 28, 2001, U.S. patent application Ser. No. 10/128,141, entitled “Methods, Systems, and Emails to Link Emails to Matter and Organizations,” filed on Apr. 23, 2002, to U.S. patent application Ser. No. 10/143,506, entitled “Methods for Synchronizing Information in Multiple Case Management Systems”, filed on May 10, 2002, each of which are incorporated herein by reference.

### FIELD OF THE INVENTIVE SUBJECT MATTER

The present inventive subject matter relates to document management, more particularly to a system and method for information disclosure statement management.

### BACKGROUND

Under the laws and regulations of various patenting authorities, patent applicants are required to disclose various documents known to the applicant to be relevant to the patentability of the patent application. These documents come to the attention of applicants in many ways such as from a foreign patenting authority. In such cases, the applicant may be required to disclose such a document to another patenting authority where the same application is pending or in all cases where related applications are pending. Under such scenarios, determining which authorities and for which applications the document must be disclosed is generally a very time consuming process. Further, determining which patenting authorities the document must be disclosed to can be also be a difficult, time-consuming process due not only to a relevancy determination, but also to varying standards for required disclosures under the laws and regulations of the various patenting authorities.

### BRIEF DESCRIPTION OF THE DRAWINGS

FIG. 1 shows a system according to one embodiment of the present inventive subject matter.

FIG. 2 shows a system according to one embodiment of the present inventive subject matter.

FIG. 3 a method according to one embodiment of the present inventive subject matter.

### DETAILED DESCRIPTION

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

System Embodiments. FIG. 1 shows a system 100 according one embodiment of the present inventive subject matter. This embodiment includes a processor 102, a memory 104, software 106, and a database 108 in the memory 104.

In some embodiments, the system 100 is a personal computer. In other embodiments, the system is a server accessible over a network but client computers. In yet further embodiments, the system 100 is a cluster of servers and other computing and storage devices in a datacenter providing computing, storage, and other resources over a network.

In some embodiments, the processor of 102 of the system 100 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 102 executes instructions. The processor 102 also includes a control unit that organizes data and program storage in memory 104 and transfers data and other information in and out of the system 100 and to and from other resources such as a network and other networked devices.

The memory 104 represents one or more mechanisms for storing data. For example, in some embodiments, the memory 104 includes read only memory (ROM), random access memory (RAM), magnetic disk storage media, optical storage media, flash memory devices, and/or other machine-readable media. In other embodiments, any appropriate type of storage device may be used. Although only one memory 104 is shown, multiple memories and storage devices and multiple types of storage devices may be present. In various embodiments, some or all of the software 108, or other items shown as stored within the memory 104 may be stored on the same or on different memory or storage devices. Furthermore, although the system 100 is shown to contain the memory 104, it may be distributed across other computing devices, such as other computing devices attached a network.

In some embodiments, the software 108 is operable on the processor 102 to maintain a patent application case database in the memory 104.

In some such embodiments, the patent application database includes data about each case. In various embodiments, for each patent application, or patent issued therefrom, the data includes some or all of an application number, a patent number, a priority date, inventory name(s), inventor address(es), assignee name(s), an indicator for associated applications, reference documents, text of a pending or issued claim set, and various other types of data pertinent to a pending patent application or issued patent.

In some embodiments, the electronic representations of the reference documents are included in the database. In one such embodiment, the reference documents are stored as Portable Document Format (PDF) files. Such PDF files can be created using Adobe Acrobat which is available from Adobe System Incorporated of San Jose, Calif.

In various embodiments, associated applications include continuing applications, divisional applications, and applications of closely related or otherwise associated subject matter. In some embodiments, the system 100 includes rules for associating references. These rules are specified by a user of a system 100 and cause the system 100 to automatically associate reference documents with related patent applications.

In some further embodiments, the software 108 is operable on the processor 102 to receive a reference document into the database and associate the document with a first case. The software is further operable on the processor to derive keywords from a pending claim set for the first case, and perform a keyword analysis on the reference document based on occurrences of the keywords in the reference document to derive a score. In yet further embodiments, the software 108 is operable on the processor 102 to associate the reference document with application related to the first application based on the score and mark the reference document for inclusion in a disclosure statement to a patenting authority based on the score, such as a Form 1449 for submission with an Information Disclosure Statement (IDS) to the United States Patent and Trademark Office.

In some embodiments, the keyword analysis includes extracting keywords from a pending claim set located in the database for a pending application. In some such embodiments, the keywords in the pending claim set are automatically extracted from the claim set. One such embodiment operates by removing commonly used words, such as “A”, “the”, “of”, etc., or word types such as prepositions, verbs, nouns, etc., and performing the keyword search on a reference document using the remaining words. Other embodiments use the entire claim set. Yet further embodiments extract certain word types, such as gerund or verb, for use in the keyword search.

A keyword search is then performed by the software 108 to derive a score for the reference document in comparison to the patent application. This score, in some embodiments, is based on the occurrence(s) of the keywords from the pending claim set in the reference document. The higher the score, the more relevant the reference document is to the patent application. Or a reverse model can be used where points are subtracted based on the non-occurrence of keywords. These are mere exemplary models for keyword scoring. Other models will be readily apparent to one implementing such a system 100. The score is then used to determine if the reference document should be provided in a disclosure statement to a patenting authority. If the score meets a certain criteria, the document is marked in the database for disclosure.

Some further embodiments take into account further reference document data such as a priority date of the document, the author of the reference document, and/or the entity owning the subject matter of the reference document. Further information, in various embodiments, includes number of patent applications the reference document was cited against, a number of times the reference document has been cited in other patent applications, reference document source. Such information is useful for many purposes.

Such information for the reference documents, represented electronically, is useful in various embodiments to provide even more relevant scoring for reference documents. For example, if the patent application has a priority date prior to the priority date of the reference document, the document may not need to be disclosed to the patenting authority. Thus, despite the results of a keywords search, the document would not be marked for disclosure. Further, these types of data can be used to improved the efficiency of the system 100 by eliminating unnecessary processing of disclosure documents by looking to the priority dates of the disclosure document prior to doing a keyword analysis. If the document would not be disclosed because the reference document has a subsequent priority date, the keyword analysis processing would be eliminated. Another rule can be defined to flag references associated with a patent application that can be sworn behind (i.e., sworn behind using a 37 CFR 1.131 affidavit for submission to the United States Patent and Trademark Office). Further rules can be defined in the system 100 for reference documents based on one or more data elements of reference documents in relation to other data in the patent application database.

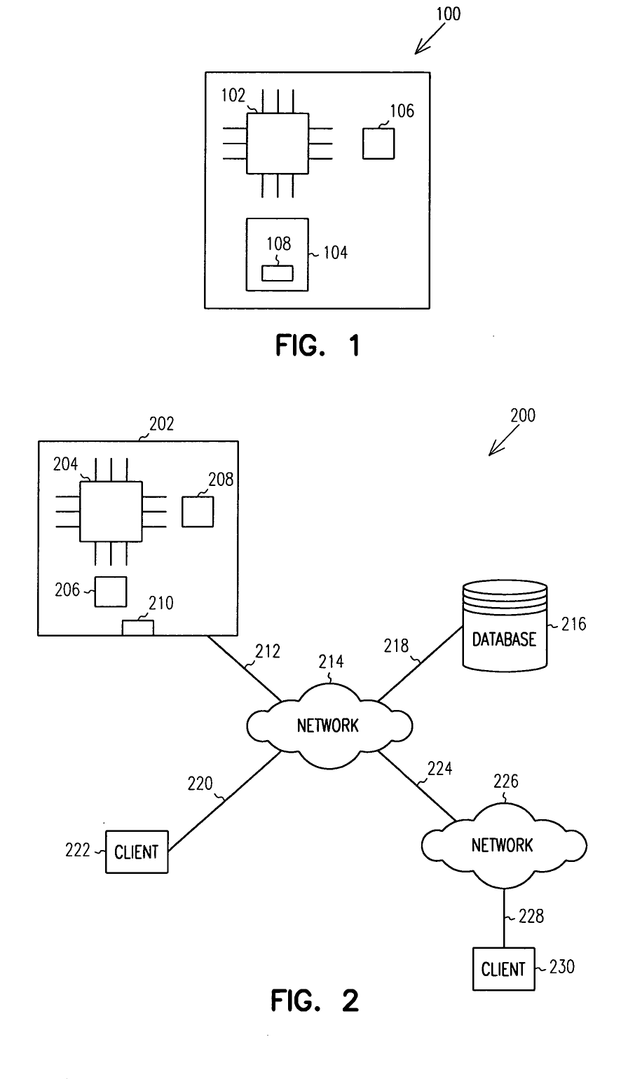

FIG. 2 shows a system 200 according one embodiment of the present inventive subject matter. In some embodiments, the system 200 includes a server 202 having a processor 204, a memory 206, a network interface 210, and software 208 that is operable on the processor 204. Some embodiments include a database 216 operatively coupled 218 to the network 214. Further, server 202 is operatively coupled 212 to a network 214 and the network 214, in some embodiments, is also operatively coupled 224 to a second network 226.

In some embodiments, the database 216 is a relational database managed by a relational database management system (RDBMS) such as Microsoft SQLServer available from Microsoft Corporation of Redmond, Washington. In other embodiments, the database is one or more flat-files arranged in a manner suitable for holding data relevant to the specific implementation. In some embodiments, the database 216 includes electronic representations of disclosure documents. In other embodiments, the database 216 includes reference to a location on the network 214 where an electronic representation of the reference document is located.

In various embodiments, the network 214 is a local area network (LAN), a wide area network (WAN), a hybrid LAN/WAN network, or other similar type or combination of two or more network types. In some such embodiments the network 214 communication technology includes a wired network, such as a 100 base-T Ethernet network, a wireless network such as an I.E.E.E. standard 802.11 a/b/g network, or other similar type or combination of wired and wireless technologies. In some embodiments, a client 222 is operatively coupled 220 to the network 214. In some such embodiments, the client 222 can access information from the server 202 over the network 214.

In some embodiments, the second network 226 is the Internet. In some embodiments, a client 230 operatively coupled 228 to the second network 226 can access information from the server 202 over the second network 226.

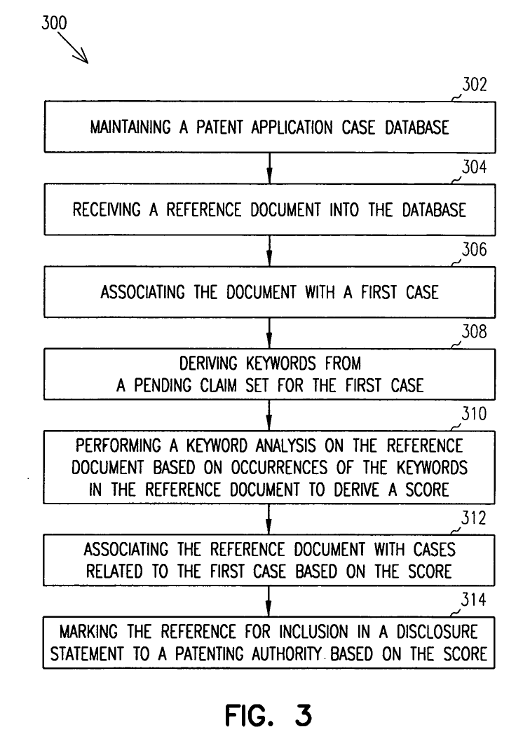

Method Embodiments. Some embodiments of the present inventive subject matter include methods for electronic management of reference documents for a universe of patent applications and patents issued therefrom. One such embodiment is illustrated in FIG. 3. In some embodiments, the method 300 includes maintaining a patent application case database 302, receiving a reference document into the database 304, and associating the document with a first case 306. Some further embodiments of the method 300 include deriving keywords from a pending claim set for the first case 308, performing a keyword analysis on the reference document based on occurrences of the keywords in the reference document to derive a score 310, and associating the reference document with cases related to the first case based on the score 312. Yet a further embodiments of the system 300 includes marking the reference for inclusion in a disclosure statement to a patenting authority based on the score 314.

Some other embodiments of the system 300 include associating the reference document 306 based on the priority date of the reference document in relation to priority dates of cases related to the first case. Another embodiment of the system 300 includes associating the reference document 306 includes the application of a rule to the score to determine if the reference document should be associated with cases related to the first case.

It is understood that the above description is intended to be illustrative, and not restrictive. Many other embodiments will be apparent to those of skill in the art upon reviewing the above description. The scope of the inventive subject matter should, therefore, be determined with reference to the appended claims, along with the full scope of equivalents to which such claims are entitled.

1. A method comprising:
maintaining a patent application case database, wherein the database includes data about each case, the data including:
a priority date,
an association of related cases,
reference documents, including a priority date for each reference document, and
a pending claim set;
receiving a reference document into the database;
associating the document with a first case;
deriving keywords from a pending claim set for the first case;
performing a keyword analysis on the reference document based on occurrences of the keywords in the reference document to derive a score;
associating the reference document with cases related to the first case based on the score; and
marking the reference for inclusion in a disclosure statement to a patenting authority based on the score.

2. The method of claim 1, wherein the associating the reference document is further based on the priority date of the reference document in relation to priority dates of cases related to the first case.

3. The method of claim 1, wherein the associating the reference document with cases related to the first case based on the score includes the application of a rule to the score to determine if the reference document should be associated with cases related to the first case.

4. The method of claim 3, wherein the rule is a threshold score.

5. The method of claim 4, wherein the rule specifies score must meet or exceed the threshold score.

6. The method of claim 3, wherein the rule includes one or more elements, the elements selected from a group including:
comparison of a priority date of the reference document and a priority date of the first document;
the score from the keyword analysis in relation to a threshold;
reference document source; and
a priority date in relation to an electronic representation of a statutory or regulatory rule.

7. The method of claim 6, wherein the rule elements, alone or in combination, specify whether the reference document is to be cited in the first case.

8. The method of claim 6, wherein the rule elements, alone or in combination, specify whether the reference document is to be associated with cases related to the first case.

9. A method comprising:
receiving a reference document into a patent case database;
associating the document with a first case in the patent case database, wherein the data for the first case includes data about one or more elements of the first case; and
performing an analysis on the reference document based on a selection of the one or more elements of the first case to derive a score.

10. The method of claim 9 further comprising:
associating the reference document with cases related to the first case based on the score from the analysis.

11. The method of claim 10, wherein the reference document is associated with a second case as a result of the analysis, the method further comprising:
performing an analysis on the reference document based on one or more elements maintained in the database about the second case.

12. The method of claim 9, wherein the data about the one or more elements of the first case is selected from a group including one or more of the following: a priority date, a classification, one or more key words, inventor, assignee, pending claim set, and inventive field.

13. The method of claim 9 further comprising:
marking the reference for inclusion in a disclosure statement to a patenting authority based on the score.

14. A method of tracking reference documents relevant to pending patent applications that includes electronically comparing keywords from a pending claim set with reference document text to automatically determine if a reference document needs to be submitted to a patent office for a pending patent application.

15. A system comprising:
a processor;
a memory;
software operable on the processor to:
maintain a patent application case database in the memory, wherein the database includes data about each case, the data including:
a priority date,
an association of related cases,
reference documents, including a priority date for each reference document, and
a pending claim set;
receive a reference document into the database;
associate the document with a first case;
derive keywords from a pending claim set for the first case;
perform a keyword analysis on the reference document based on occurrences of the keywords in the reference document to derive a score;
associate the reference document with cases related to the first case based on the score; and
mark the reference document for inclusion in a disclosure statement to a patenting authority based on the score.

16. The system of claim 15, wherein the software is further operable on the processor to:
associate the reference document based on the priority date of the reference document in relation to priority dates of cases related to the first case.

17. The system of claim 15, wherein the software is further operable on the processor to:
associate the reference document with cases related to the first case based application of a rule to the score to determine if the reference document should be associated with cases related to the first case.

18. A system comprising:
a processor;
a memory;
software operable on the processor to cause the system to:
receive a reference document into a patent case database located in the memory;
associate the reference document with a first case in the patent case database, wherein the data for the first case includes data about one or more elements of the first case; and
perform an analysis on the reference document based on a selection of the one or more elements of the first case to derive a score.

19. The system of claim 18, wherein the software is further operable on the processor to:
associate the reference document with cases related to the first case based on the score from the analysis.

20. The system of claim 19, wherein the software is further operable on the processor to:
associate the reference document with a second case as a result of the analysis; and
perform an analysis on the reference document based on one or more elements maintained in the database about the second case.

21. The system of claim 18, wherein the software is further operable on the processor to:
mark the reference for inclusion in a disclosure statement to a patenting authority based on the score.

22. A system comprising:
a processor;
a memory; and
software operable on the processor for electronically comparing keywords from a pending claim set with reference document text to automatically determine if a reference document needs to be submitted to a patent office for a pending patent application, the keywords and the reference document text located in the memory.

23. A system comprising:
a network;
a database, wherein the database is a patent case database, further wherein the database is accessible on the network; and
a server, operatively connected to the network, wherein the server includes:
a processor,
a memory,
software operable on the processor to:
receive a reference document,
associate the reference document with a first case in the database,
retrieve one or more elements from the database of the first case,
perform an analysis on the reference document based on a selection of the one or more elements from the database of the first case to derive a score for the reference document,
store the score in the database, associating the score with the reference document and the first case, and
receive and respond to requests over the network from a client for patent case data stored on the database.

24. The system of claim 23, wherein the software is further operable on the processor of the server to:
receive commands from the client to prepare a document disclosure for submission to a patent authority, wherein the document disclosure is prepared based on the derived score for the reference document based on the first case.

25. The system of claim 24, wherein the software is further operable on the processor to:
deliver the document disclosure to the client over the network.

26. The system of claim 24, wherein the software is further operable on the processor to:
electronically deliver the document disclosure to the patenting authority.

27. The system of claim 26, wherein the document disclosure is electronically delivered via facsimile.

28. The system of claim 26, wherein the document disclosure is electronically delivered via the Internet.

29. The system of claim 24, wherein the patenting authority is the United States Patent and Trademark Office.

30. The system of claim 30, wherein the network is the Internet.
